(19) United States
(12) Patent Application Publication
(10) Pub. No.: US 2022/0156113 A1
(43) Pub. Date: May 19, 2022

(54) Network Service Load Distribution System And Method Thereof

(71) Applicants: Inventec (Pudong) Technology Corporation, Shanghai (CN); Inventec Corporation, Taipei City (TW)

(72) Inventor: Zhi-Nan Guo, Shanghai (CN)

(21) Appl. No.: 17/125,892

(22) Filed: Dec. 17, 2020

(30) Foreign Application Priority Data
Nov. 17, 2020 (CN) 202011285388.6

(51) Int. Cl. G06F 9/50

(52) U.S. Cl. CPC G06F 9/505; G06F 2209/501; G06F 9/5072; G06F 9/5077

(57) ABSTRACT

A network service load distribution system and a method thereof are disclosed. In the system, each of service servers generates a message queue for hardware performance data thereof based on identification information and service content thereof, a load distribution server receives the message queues from the service servers through subscription. The load distribution server polls one of the service servers to acquire the message queue to retrieve the hardware performance data of the polled service server. When the hardware performance data or the hardware performance calculation data of the polled service server is higher than or equal to a threshold value, the load distribution server accumulates a performance alert indicator of the polled service server and polls another of the service servers, thereby achieving the technical effect of providing a reasonable network service load distribution.

### BACKGROUND OF THE INVENTION

### 1. Field of the Invention

The present invention is related to a load distribution system and a method thereof, and more particularly to a network service load distribution system and a method thereof, in which each service server can provide hardware performance data thereof to a load distribution server through a message queue, and the load distribution server can poll the service servers according to the hardware performance data of the service servers, so as to perform service load distribution.

### 2. Description of the Related Art

With the increasing complexity of network service functions and the obvious increase in traffic caused by network services, it is necessary to expand network services for decentralized deployment to solve the problem that single-point service may be unavailable when a large amount of concurrent accesses occur.

The existing solution for this problem is to set up a load balancing device responsible for distributing front-end requests to back-end services. The load balancing device can be implemented by hardware or software and operated based on configuration strategies, for example, the service is provided based on the number of the service servers in order, based on the priority of the designated service server, or based on the network delay time of the service server, and so on.

Furthermore, the load balancing device can also monitor the health status of the service server to identify and remove the unavailable service server from the service server list; after the service server is restored to be usable, the load balancing device can add the restored service server into the service server list. The conventional load balancing device can have more comprehensive consideration for service requests, but in the actual operation process, some service servers may often execute more complex logic calculation, which occupies excessive system resources, and fail to respond other service request timely when being still required to provide services again; however, at the same time, some other service servers basically not consumed in resources and staying in idle statuses are not assigned to provide services.

Therefore, what is needed is to develop an improved technical solution to solve the problem that the existing network service load distribution is not reasonable.

### SUMMARY OF THE INVENTION

In order to solve the conventional technical problem that the existing network service load distribution is not reasonable, the present invention provides a network service load distribution system and a method thereof.

According to an embodiment, the present invention provides a network service load distribution system including a plurality of service servers and a load distribution server. Each service server includes an information collection module, a database, a generating module, and a message queue transmission module. The information collection module is configured to collect hardware performance data of the service server. The database is configured to store the hardware performance data of the service server based on a system time of collecting the hardware performance data of the service server. The generating module is configured to generate a message queue from the hardware performance data of the service server based on identification information of the service server and service content of the service server. The message queue transmission module is configured to transmit the message queue.

The load distribution server includes a receiving module, a calculation module, a polling module, a data acquisition module and a load distribution module. The receiving module is configured to receive the message queue from the message queue transmission module through subscription. The calculation module is configured to perform calculation on the hardware performance data of the service server to generate hardware performance calculation data when the service content in the message queue of the service server is a specific service content. The polling module is configured to poll the service server according to a polling sequence. The data acquisition module is configured to acquire the message queue of the polled service server to retrieve the hardware performance data of the polled service server or retrieve the hardware performance calculation data of the polled service server. The load distribution module is configured to accumulate a performance alert indicator of the polled service server and notify the polling module to poll another of the plurality of service servers when the hardware performance data of the polled service server is determined to be higher than or equal to a threshold value or the hardware performance calculation data of the polled service server is determined to be higher than or equal to the threshold value, and the load distribution module removes the polled service server from the polling sequence when the performance alert indicator of the polled service server is higher than or equal to a preset value.

According to an embodiment, the present invention provides a network service load distribution method includes steps of: providing a plurality of service servers, wherein each of the plurality of service servers collects hardware performance data thereof; storing, by the service server, the hardware performance data of the service server based on a system time of collecting the hardware performance data of the service server; generating, by each of the plurality of service servers, a message queue from hardware performance data of each of the plurality of service servers based on identification information and service content of each of the plurality of service servers; transmitting the message queues from the service servers; receiving the message queues, by a load distribution server, from the plurality of service servers through subscription; performing, by the load distribution server, data calculation on the hardware performance data of at least one of the plurality of service servers to generate hardware performance calculation data when the service content in the message queue of the at least one of the plurality of service servers is a specific service content; polling, by the load distribution server, at least one of the plurality of service servers according to a polling sequence; acquiring, by the load distribution server, the message queue of the polled service server to retrieve the hardware performance data or the hardware performance calculation data of the polled service server; when the hardware performance data of the polled service server is determined to be higher than or equal to a threshold value, or the hardware performance calculation data of the polled service server is determined to be higher than or equal to the threshold value, accumulating, by the load distribution server, a performance alert indicator of the polled service server and polling another of the plurality of service servers; and when the performance alert indicator of the polled service server is higher than or equal to a preset value, removing, by the load distribution server, the polled service server from the polling sequence.

According to above-mentioned system and method of the present invention, the difference between the present invention and the conventional technology is that, in the present invention, the service server can generate a message queue for hardware performance data thereof based on identification information and service content thereof, the load distribution server can receive the message queue from the service server through subscription, the load distribution server can poll one of the service servers and acquires the message queue of the polled service server to retrieve the hardware performance data of the polled service server, and when the hardware performance data of the polled service server is determined to be higher than or equal to a threshold value, or the hardware performance calculation data of the polled service server is determined to be higher than or equal to the threshold value, the load distribution server accumulates the performance alert indicator of the polled service server, and polls another of the service servers.

Through aforementioned technical solution, the present invention can achieve the technical effect of providing the reasonable network service load distribution.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a network service load distribution system of the present invention.

FIG. 2 is a schematic view of an architecture for a network service load distribution of the present invention.

FIGS. 3A and 3B are flowcharts of a network service load distribution method of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular firms “a”, “an” and “the” are intended to include the plural forms as well, unless the context clearly indicates otherwise.

It is to be acknowledged that, although the terms ‘first’, ‘second’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present.

In addition, unless explicitly described to the contrary, the word “comprise” and variations such as “comprises” or “comprising”, will be acknowledged to imply e inclusion of stated elements but not the exclusion of any other elements.

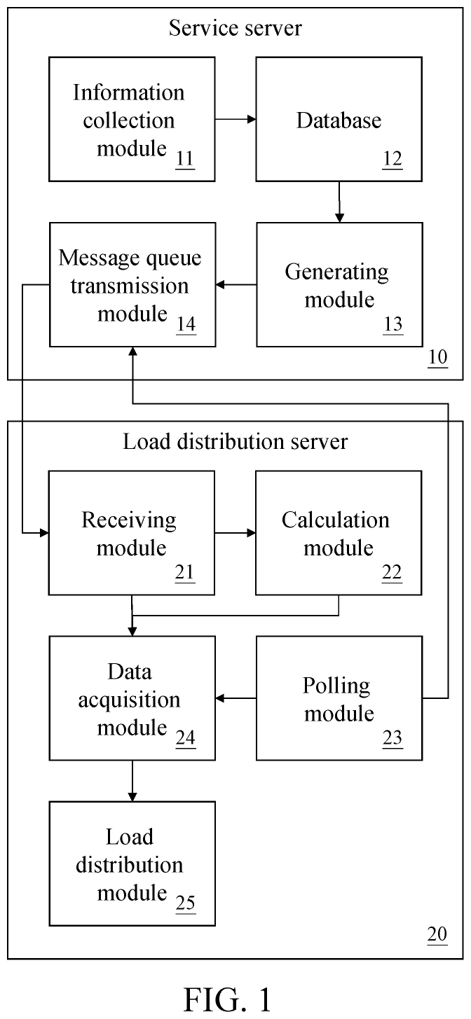

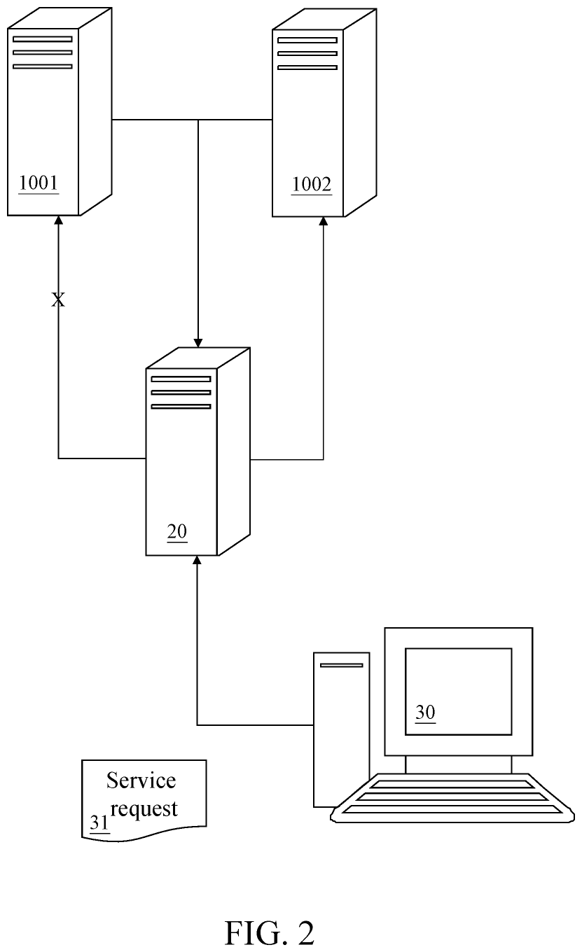

The network service load distribution system of the present invention is described in the following paragraphs. Please refer to FIGS. 1 and 2. FIG. 1 is a system block diagram of a network service load distribution system of the present invention, and FIG. 2 is a schematic view of an architecture for a network service load distribution of the present invention.

As shown in FIGS. 1 and 2, the network service load distribution system of the present invention includes a plurality of service servers 10 and a load distribution server 20, and each of the plurality of service servers 10 includes an information collection module 11, a database 12, a generating module 13, and a message queue transmission module 14. The load distribution server 20 includes a receiving module 21, a calculation module 22, a polling module 23, a data acquisition module 24 and a load distribution module 25.

Each of the plurality pf service servers 10 is configured to provide a network service required by a user, and different service servers 10 can provide different network services to the user. The information collection module 11 of the service server 10 is configured to collect the hardware performance data of the service server 10. In the present invention, each network service can be provided by at least two service servers 10.

In an embodiment, the aforementioned hardware performance data can include a utilization rate of CPU, a utilization rate of memory, free space in memory, input/output operations per second of hard disk, a network throughput, network delay, an average service response time, a data, throughput, or a combination thereof; however, these examples are merely for exemplary illustration, and the application field of the present invention is not limited thereto.

After the information collection module 11 of the service server 10 collects the hardware performance data of the service server 10, the hardware performance data of the service server 10 is stored in the database 12 of the service server 10 according to the system time of collecting the hardware performance data of the service server 10.

After the information collection module 11 of the service server 10 collects the hardware performance data of the service server 10, the generating module 13 of the service server 10 generate a message queue for the hardware performance data of the service server 10 based on identification information of the service server 10 and service content of the service server 10.

For example, the identification information of the service server 10 can include media access control (MAC) address or internet protocol UP) address; however, these examples are merely for exemplary illustration, and the application field of the present invention is not limited thereto. For example, the service content of the service server 10 can include a login service, a query service, a search service or a calculation service; however, these examples are merely for exemplary illustration, and the application field of the present invention is not limited thereto.

When the generating module 13 of the service server 10 generates the message queue for the hardware performance data of the service server 10 based on the identification information and the service content of the service server 10, the message queue can be transmitted through the message queue transmission module 14 of the service server 10.

The load distribution server 20 can establish interconnection with each of the service servers 10 through wired transmission manner or wireless transmission manner. In an embodiment, for example, the wired transmission manner can be a power line network, an optical network, and so on; and the wireless transmission manner can be Wi-Fi, or mobile communication network such as 3G, 4G, 5G and so on, these examples are merely for exemplary illustration, and the application field of the present invention is not limited thereto.

After the message queue transmission module 14 of the service server 10 transmits the message queue, so that the receiving module 21 of the load distribution server 20 can receive the message queue from the message queue transmission module 14 of each of the service servers 10 through subscription.

When the service content contained in the message queue of the service server 10 is a specific service content, the calculation module 22 of the load distribution server 20 performs data calculation on the hardware performance data of the service server 10 to generate hardware performance calculation data.

For example, when the service content of the service server 10 is a query service or a search service, the calculation module 22 of the load distribution server 20 performs corresponding data calculation on the hardware performance data of the service server 10 to generate hardware performance calculation data, which can include an average service response time and a data throughput; however, these examples are merely for exemplary illustration, the application field of the present invention is not limited thereto.

When a user equipment 30 issues the service request 31, the load distribution server 20 needs to perform distribution on the service servers 10 in response to the service request 31 issued from the user equipment 30, and the polling module 23 of the load distribution server 20 polls at least one of the service servers 10 according to a polling sequence in response to the service request.

Particularly, in a condition that both of the first service server 1001 and the second service server 1002 can provide the query service, when the load distribution server 20 needs to perform distribution on the service servers 10 in response to the service request 31 being “query service”, the polling module 23 of the load distribution server 20 polls the first service server 1001 and the second service server 1002 according to the polling sequence in response to the service request 31 being “query service”; however, these examples are merely for exemplary illustration, and the application field of the present invention is not limited thereto.

Next, the data acquisition module 24 of the load distribution server 20 acquires the message queue of the polled service server 10, to retrieve the hardware performance data or the hardware performance calculation data of the polled service server 10.

When the hardware performance data of the polled service server 10 is determined to be higher than or equal to a threshold value, or the hardware performance calculation data of the polled service server 10 is determined to be higher than or equal to the threshold value, the load distribution module 25 of the load distribution server 20 accumulates a performance alert indicator of the polled service server 10 to be polled, and then notifies the polling module 23 to poll another of the service servers 10. When the performance alert indicator of the polled service server 10 is higher than or equal to a preset value, the polled service server 10 is removed from the polling sequence.

Particularly, the polling module 23 of the load distribution server 20 polls the first service server 1001 in response to the service request 31 being “query service”, the data acquisition module 24 of the load distribution server 20 acquires the message queue of the first service server 1001 to retrieve the hardware performance data of the first service server 1001; for example, if the CPU performance contained in the retrieved hardware performance data is 85% which exceeds the threshold value of the CPU performance set as 80%, the load distribution module 25 of the load distribution server 20 accumulates the performance alert indicator of the first service server 1001 from “1” to “2” and notifies the polling module 23 to poll the second service server 1002 to provide the query service. However, these examples are merely for exemplary illustration, and the application field of the present invention is not limited thereto.

When the polling module 23 of the load distribution server 20 polls the first service server 1001 again in response to the service request 31 being “query service”, the data. acquisition module 24 of the load distribution server 20 acquires the message queue of the first service server 1001 to retrieve the hardware performance data of the first service server 1001, if the CPU performance contained in the hardware performance data is still 85% which exceeds the threshold value of the CPU performance set as 80%, the load distribution module 25 of the load distribution server 20 accumulates the performance alert indicator of the first service server 1001 from “2” to “3”, and notifies the polling module 23 to poll the second service server 1002 to provide the query service. However, these examples are merely for exemplary illustration, and the application field of the present invention is not limited thereto.

Since the performance alert indicator of the first service server 1001 is accumulated up to “3” which is equal of a preset value of “3”, the load distribution module 25 of the load distribution server 20 removes the first service server 1001 from the polling sequence, that is, when the polling module 23 of the load distribution server 20 is to poll one of the first service server 1001 and the second service server 1002 in response to the service request 31 being “query service”, the polling module 23 does not poll the first service server 1001.

When the hardware performance data of the first service server 1001, which is removed from the polling sequence, is determined to be lower than the threshold value or the hardware performance calculation data of the first service server 1001, which is removed from the polling sequence, is determined to be lower than the threshold value, the load distribution module 25 of the load distribution server 20 can add the first service server 1001 into the polling sequence and reset the performance alert indicator of the first service server 1001.

It should be noted that the calculation module 22 of the load distribution server 20 can calculate hardware performance values of the service servers 10 based on the hardware performance data of the service servers 10, and the load distribution module 25 of the load distribution server 20 can sort the service servers 10 based on the hardware performance values of the service servers 10 in an order from high to low, so as to provide the polling module 23 of the load distribution server 20 with the polling sequence for the service servers.

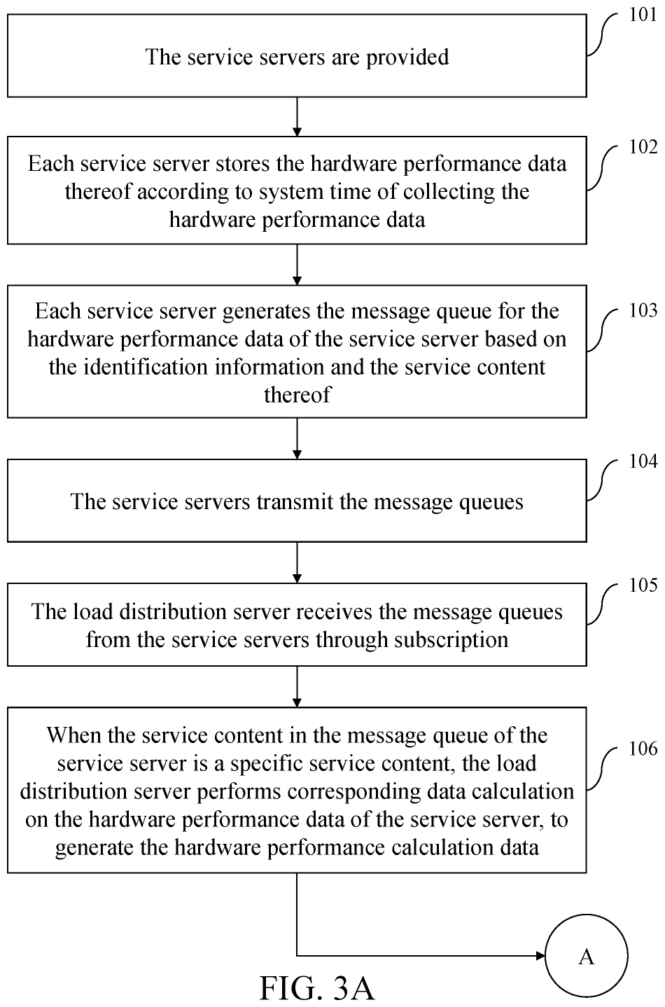

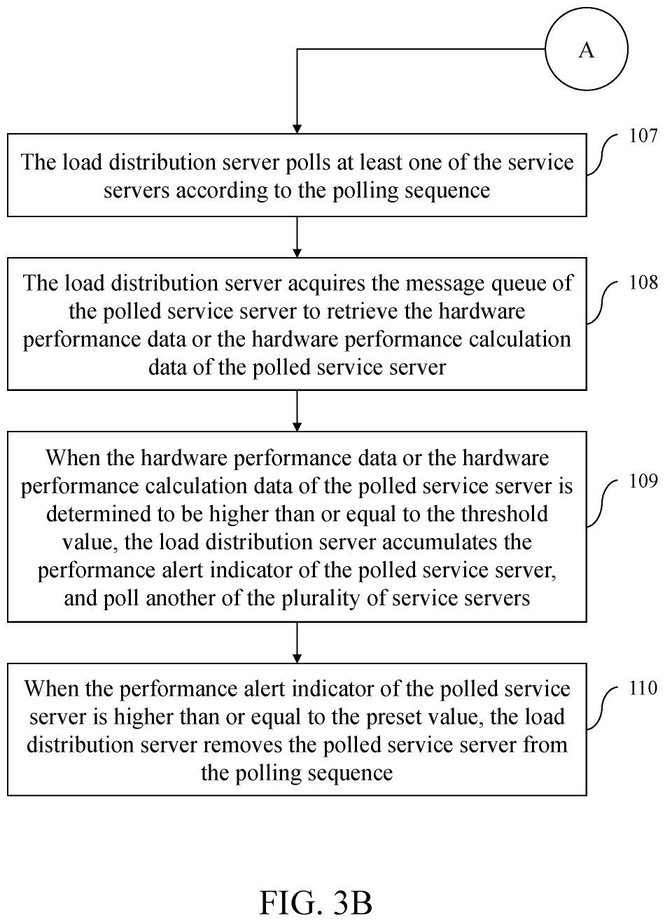

The operational flow of the method of the present invention is described in the following paragraphs. Please refer to FIGS. 3A and 3B, which are flowcharts of the network service load distribution method of the present invention.

First, in a step 101, the plurality of service servers are provided, and each service server can collect the hardware performance data thereof. In a step 102, each service server stores the hardware performance data thereof according to system time of collecting the hardware performance data. Next, in a step 103, each service server generates the message queue for the hardware performance data of the service server based on the identification information and the service content thereof. Next, in a step 104, the service servers transmit the message queues. In a step 105, the load distribution server receives the message queues from the service servers through subscription. In a step 106, when the service content in the message queue of the service server is a specific service content, the load distribution server performs corresponding data calculation on the hardware performance data of the service server, to generate the hardware performance calculation data. In a step 107, the load distribution server polls at least one of the service servers according to the polling sequence.

In a step 108, the load distribution server acquires the message queue of the polled service server to retrieve the hardware performance data of the polled service server or retrieve the hardware performance calculation data of the polled service server. In a step 109, when the hardware performance data of the polled service server is determined to be higher than or equal to a threshold value, or the hardware performance calculation data of the polled service server is determined to be higher than or equal to the threshold value, the load distribution server accumulates the performance alert indicator of the polled service server and polls another of the plurality of service servers. In a step 110, when the performance alert indicator of the polled service server is higher than or equal to the preset value, the load distribution server removes the polled service server from the polling sequence.

According to above-mentioned contents, the difference between the present invention and conventional technology is that, in the present invention, the service server can generate the message queue for the hardware performance data of the service server based on the identification information and the service content of the service server, and the load distribution server receives the message queue from the service server through subscription, the load distribution server acquires the message queue of the polled service server to retrieve the hardware performance data of the polled service server, and when the hardware performance data of the polled service server is determined to be higher than or equal to the threshold value or the hardware performance calculation data of the polled service server is determined to be higher than or equal to the threshold value, the load distribution server accumulates the performance alert indicator of the polled service server, and the polling module 23 is notified to poll another of the plurality of service servers again.

The technical solution of the present invention can solve the conventional technical problem that the existing network service load distribution is not reasonable, so as to achieve the technical effect of providing the reasonable network service load distribution.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A network service load distribution system, comprising:
a plurality of service servers, wherein each of the plurality of service servers comprises:
an information collection module configured to collect hardware performance data of the service server;
a database configured to store the hardware performance data of the service server based on a system time of collecting the hardware performance data of the service server;
a generating module configured to generate a message queue from the hardware performance data of the service server based on identification information of the service server and service content of the service server; and
a message queue transmission module configured to transmit the message queue; and
a load distribution server comprising:
a receiving module configured to receive the message queue from the message queue transmission module through subscription;
a calculation module configured to perform calculation on the hardware performance data of the service server to generate hardware performance calculation data when the service content in the message queue of the service server is a specific service content;
a polling module configured to poll the service server according to a polling sequence;
a data acquisition module configured to acquire the message queue of the polled service server to retrieve the hardware performance data of the polled service server or retrieve the hardware performance calculation data of the polled service server; and
a load distribution module configured to accumulate a performance alert indicator of the polled service server and notify the polling module to poll another of the plurality of service servers when the hardware performance data of the polled service server is determined to be higher than or equal to a threshold value or the hardware performance calculation data of the polled service server is determined to be higher than or equal to the threshold value, and the load distribution module removes the polled service server from the polling sequence when the performance alert indicator of the polled service server is higher than or equal to a preset value.

2. The network service load distribution system according to claim 1, wherein when the hardware performance data of the service server, which is removed from the polling sequence, is determined to be lower than the threshold value, or the hardware performance calculation data of the service server, which is removed from the polling sequence, is determined to be lower than the threshold value, the load distribution module adds the service server into the polling sequence and resets the performance alert indicator of the service server.

3. The network service load distribution system according to claim 1, wherein the calculation module calculates hardware performance values based on the hardware performance data of the plurality of service servers, the load distribution module sorts the plurality of service servers based on the hardware performance values in an order from high to low, so as to provide the polling module with a polling sequence for the plurality of service servers.

4. The network service load distribution system according to claim 1, wherein the hardware performance data of each of the plurality of service servers comprises a utilization rate of CPU, a utilization rate of memory, free space in memory, input/output operations per second of hard disk, a network throughput, a network delay, or a combination thereof.

5. A network service load distribution method, comprising:
providing a plurality of service servers, wherein each of the plurality of service servers collects hardware performance data thereof;
storing, by the service server, the hardware performance data of the service server based on a system time of collecting, the hardware performance data of the service server;
generating, by each of the plurality of service servers, a message queue from hardware performance data of each of the plurality of service servers based on identification information and service content of each of the plurality of service servers;
transmitting the message queues from the service servers;
receiving the message queues, by a load distribution server, from the plurality of service servers through subscription;
performing, by the load distribution server, data calculation on the hardware performance data of at least one of the plurality of service servers to generate hardware performance calculation data when the service content in the message queue of the at least one of the plurality of service servers is a specific service content;
polling, by the load distribution server, at least one of the plurality of service servers according to a polling sequence;
acquiring, by the load distribution server, the message queue of the polled service server to retrieve the hardware performance data or the hardware performance calculation data of the polled service server;
when the hardware performance data of the polled service server is determined to be higher than or equal to a threshold value, or the hardware performance calculation data of the polled service server is determined to be higher than or equal to the threshold value, accumulating, by the load distribution server, a performance alert indicator of the polled service server and polling another of the plurality of service servers; and
when the performance alert indicator of the polled service server is higher than or equal to a preset value, removing, by the load distribution server, the polled service server from the polling sequence.

6. The network service load distribution method according to claim 5. further comprising:
adding, by the load distribution server, the service server into the polling sequence and resetting the performance alert indicator of the service server when the hardware performance data of the service server, which is removed from the polling sequence, is determined to be lower than a threshold value, or the hardware performance calculation data of the service server, which is removed from the polling sequence, is determined to be lower than the threshold value,.

7. The network service load distribution method according to claim 5, further comprising, calculating, by the load distribution server, hardware performance values based on the hardware performance data of the plurality of service servers;
sorting the plurality of service servers based on the hardware performance values in an order from high to low, to provide the polling sequence for the plurality of service servers,

8. The network service load distribution method according to claim 5, wherein the hardware performance data of each of the plurality of service servers comprises a utilization rate of CPU, a utilization rate of memory, free space in memory, input/output operations per second of hard disk, a network throughput, a network delay or a combination thereof.
